(19) United States
(12) Patent Application Publication
(10) Pub. No.: US 2026/0228455 A1
(43) Pub. Date: Aug. 6, 2026

(54) INFORMATION PROCESSING APPARATUS, INFORMATION PROCESSING METHOD, AND COMPUTER PROGRAM PRODUCT

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventors: Takahiro KOZUKA, Kawasaki (JP); Shintarou TAKAHASHI, Kawasaki (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/463,316

(22) Filed: Jan. 29, 2026

(30) Foreign Application Priority Data
Feb. 6, 2025 (JP) 2025-017995

(51) Int. Cl. G06F 40/40; G06F 40/186

(52) U.S. Cl. CPC G06F 40/40; G06F 40/186

(57) ABSTRACT

An information processing apparatus includes a processor functioning as an input receiver, an analysis-planning unit, an interaction-element generator, an analysis determiner, an analysis-execution unit, and an output generator. The input receiver receives input information expressed in a natural-language from a user. The analysis-planning unit determines an abstraction-level of the natural-language by using a language model, and plans user-intended analysis-processing using the natural-language when the abstraction-level is determined as low. The interaction-element generator generates an interaction-element that more specifically specifies the user’s intention expressed in the natural-language when the abstraction-level is determined as high. The analysis determiner determines an execution method for the planned analysis-processing when the abstraction-level is determined as low. The analysis-execution unit executes the analysis-processing by the determined execution method. The output generator generates output information based on an analysis-processing result. The output unit outputs the interaction-element or the output information.

### CROSS-REFERENCE TO RELATED APPLICATIONS

This application is based upon and claims the benefit of priority from Japanese Patent Application No. 2025-017995, filed on February 6, 2025; the entire contents of which are incorporated herein by reference.

### FIELD

Embodiments described herein relate generally to an information processing apparatus, an information processing method, and a computer program product.

### BACKGROUND

In recent years, digital transformation (DX) has been promoted in the fields of manufacturing and social infrastructure, and a wide variety of data such as a text, sensor data, an image, and a sound has been collected and accumulated. Useful information leading to decision-making is acquired from the accumulated data, and is used to maintain and enhance the competitiveness of companies.

However, in the related art, it is difficult to more effectively support data analysis.

### BRIEF DESCRIPTION OF THE DRAWINGS

FIG. 1 is a diagram illustrating an example of a functional configuration of an information processing apparatus according to a first embodiment;

FIG. 2 is a diagram for describing a first example of information processing according to the first embodiment;

FIG. 3 is a diagram for describing a second example of the information processing according to the first embodiment;

FIG. 4 is a diagram illustrating an example of a functional configuration of an information processing apparatus according to a second embodiment;

FIG. 5 is a diagram for describing an example of information processing according to the second embodiment;

FIG. 6 is a diagram illustrating an example of a functional configuration of an information processing apparatus according to a third embodiment;

FIG. 7 is a diagram for describing an example of information processing according to the third embodiment;

FIG. 8 is a diagram illustrating an example of a functional configuration of an information processing apparatus according to a fourth embodiment;

FIG. 9 is a diagram for describing an example of information processing according to the fourth embodiment;

FIG. 10 is a diagram illustrating an example of a functional configuration of an information processing apparatus according to a fifth embodiment;

FIG. 11 is a diagram for describing an example of information processing according to the fifth embodiment; and

FIG. 12 is a diagram illustrating an example of a hardware configuration of the information processing apparatuses according to the first to fifth embodiments.

### DETAILED DESCRIPTION

According to an embodiment, an information processing apparatus includes one or more hardware processors configured to function as an input receiver, an analysis planning unit, an interaction element generator, an analysis determiner, an analysis execution unit, an output generator, and an output unit. The input receiver receives input information expressed in a natural language from a user. The analysis planning unit determines an abstraction level of the natural language by using a language model, and plans analysis processing intended by the user by using the natural language in a case where it is determined by the language model that the abstraction level is low. The interaction element generator generates an interaction element that more specifically specifies an intention of the user expressed in the natural language in a case where it is determined by the language model that the abstraction level is high. The analysis determiner determines an execution method for planned analysis processing in a case where it is determined by the language model that the abstraction level is low. The analysis execution unit executes the analysis processing by the determined execution method. The output generator generates output information based on a result of the analysis processing. The output unit outputs the interaction element or the output information.

Exemplary embodiments of an information processing apparatus, an information processing method, and a computer program product will be explained below in detail with reference to the accompanying drawings. The present disclosure is not limited to the following embodiments.

Data analysis is performed in a process of utilizing data. The data analysis is a difficult task requiring specialized knowledge such as statistics and machine learning, as well as advanced skills such as programming, and thus, only a limited number of people can engage in such work, resulting in high costs. Under such a background, in recent years, technological development of a text-to-text machine learning model including a large language model (LLM) has progressed, and it is becoming possible to generate, by using information expressed in a natural language as an input, information expressed in another natural language or source code. As a result, development of a mechanism capable of implementing advanced processing such as the data analysis without requiring experts is expected.

Conventionally, in a case where an instruction of a user is unilaterally transmitted to a data processing system, for example, the data analysis is performed even when the instruction of the user is ambiguous, and there is a case where the behavior does not meet an intention of the user.

Furthermore, for example, a user who frequently uses the data analysis system often acquires typical data analysis processing, but there is no mechanism for managing the data analysis processing, and user-side reliability or reproducibility of the processing is insufficient.

Furthermore, for example, interpretation of analysis results, confirmation of points to be noted, consideration of actions to be executed next, and the like are left to the user, which becomes a barrier to decision making of a non-expert user who does not have data analysis knowledge.

Furthermore, for example, there is no mechanism for managing prerequisite knowledge implicitly required for analysis processing, and the user needs to input a specific instruction instead of a familiar simple expression in order to execute intended analysis processing.

Hereinafter, embodiments of an information processing apparatus, an information processing method, and a computer program product capable of more effectively supporting data analysis will be described in detail with reference to the accompanying drawings.

### First Embodiment

First, an example of a functional configuration of an information processing apparatus 1 according to a first embodiment will be described.

### Example of Functional Configuration

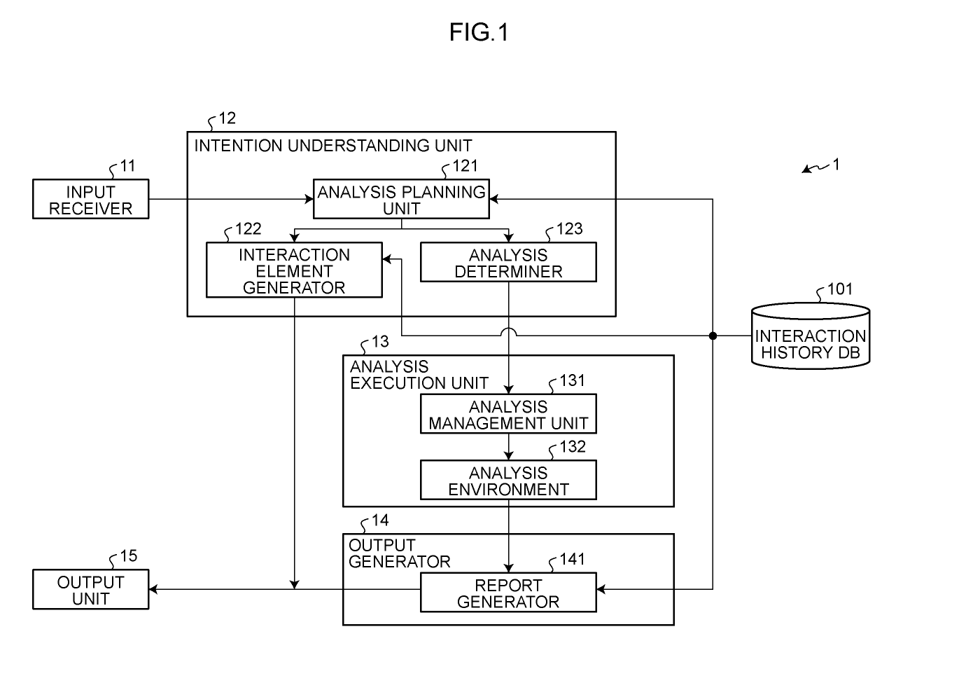

FIG. 1 is a diagram illustrating an example of the functional configuration of the information processing apparatus 1 according to the first embodiment. The information processing apparatus 1 according to the first embodiment includes an input receiver 11, an intention understanding unit 12, an analysis execution unit 13, an output generator 14, and an output unit 15. In addition, a storage device of the information processing apparatus 1 according to the first embodiment stores an interaction history database (DB) 101 therein.

The interaction history DB 101 stores an interaction history with the user therein.

The input receiver 11 receives input information expressed in a natural language from the user.

The intention understanding unit 12 includes an analysis planning unit 121, an interaction element generator 122, and an analysis determiner 123.

The analysis planning unit 121 determines an abstraction level of the natural language included in the input information by using a language model, and plans analysis processing intended by the user using the natural language in a case where it is determined by the language model that the abstraction level is low.

In a case where it is determined by the language model that the abstraction level is high, the interaction element generator 122 generates an interaction element that more specifically specifies an intention of the user expressed in the natural language included in the input information.

In a case where it is determined by the language model that the abstraction level is low, the analysis determiner 123 determines an execution method for the planned analysis processing based on, for example, the natural language included in the input information.

The analysis execution unit 13 includes an analysis management unit 131 and an analysis environment 132.

The analysis management unit 131 executes the analysis processing in the analysis environment 132 by the execution method determined by the analysis determiner 123. The analysis environment 132 is an environment in which a source code (program) is executed that implements the analysis processing.

The output generator 14 includes a report generator 141. The report generator 141 generates a report as output information based on a result of the analysis processing.

The output unit 15 outputs the above-described interaction element or the above-described output information.

### First Example of Information Processing

First, a first example of information processing according to the first embodiment will be described. In the first example of the information processing, a basic flow of the information processing according to the first embodiment will be described.

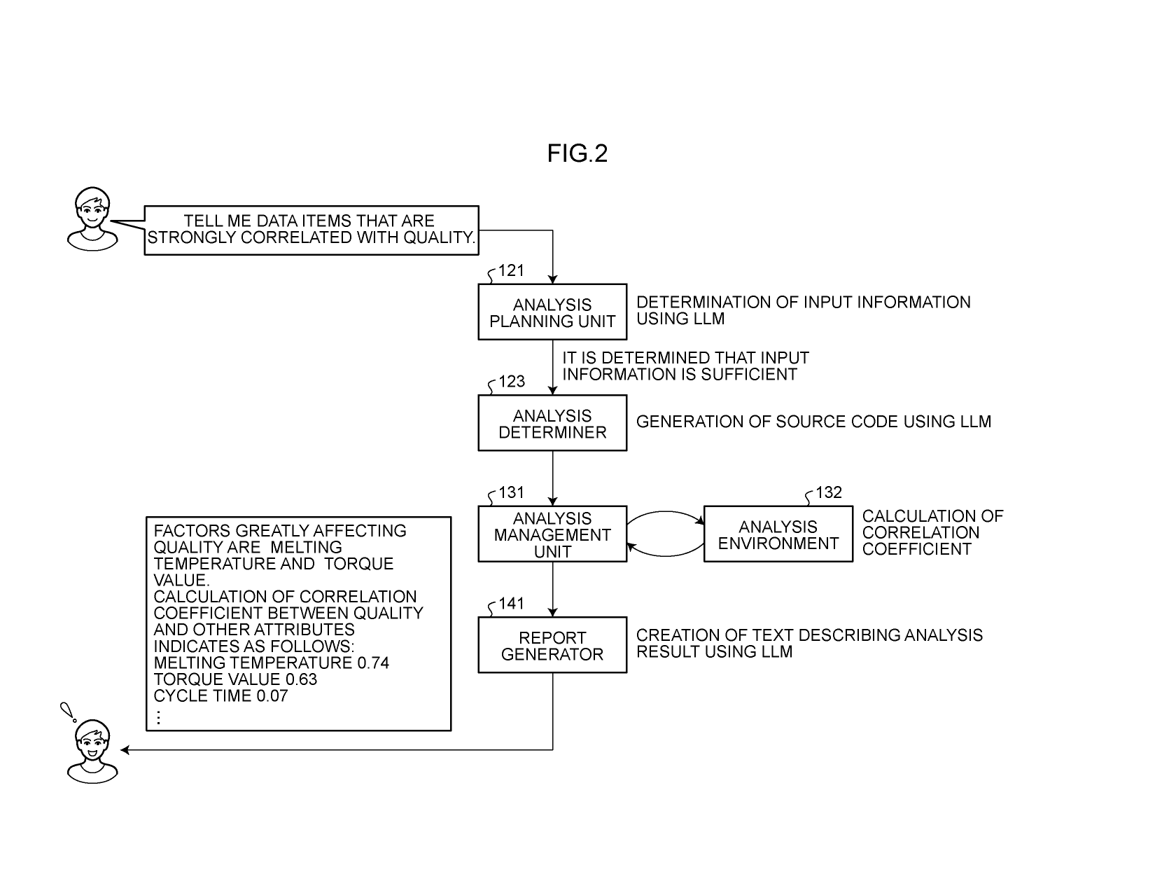

FIG. 2 is a diagram for describing the first example of the information processing according to the first embodiment. In the example of FIG. 2, the input receiver 11 receives, from the user, the input information expressed in the natural language, "Tell me data items that are strongly correlated with quality", and inputs the input information to the analysis planning unit 121.

Next, the analysis planning unit 121 determines whether or not the input information includes information sufficient for planning the analysis processing. Any method may be used for determining whether or not the input information includes information sufficient for planning the analysis processing. In the first embodiment, a method of causing the language model such as the large language model (LLM) to determine whether or not the abstraction level of the input information is high is used.

An example of a prompt for determining whether or not the input information is sufficient by using the LLM is as follows.

### Example of Prompt

Please determine whether the abstraction level of the following instruction is high.

### Instruction

Tell me data items that are strongly correlated with quality.

In a case where it is determined by using the LLM that the abstraction level is low, the analysis planning unit 121 inputs the input information to the analysis determiner 123.

Next, the analysis determiner 123 determines an analysis method for responding to the input information. Any method may be used for determining the analysis method. In the first embodiment, the analysis determiner 123 inputs, to the language model such as the LLM, the input information and the instruction to generate the source code for generating the output information according to the input information, and acquires the source code from the language model.

An example of a prompt for generating the source code using the LLM is as follows.

### Example of Prompt

Please create a Python code that executes the following instruction.

### Instruction

Tell me data items that are strongly correlated with quality.

The analysis determiner 123 inputs the source code output from the LLM to the analysis management unit 131.

Next, the analysis management unit 131 creates the analysis environment 132 for executing the source code, instructs the analysis environment 132 to execute the source code, and performs monitoring. The analysis management unit 131 inputs a result of the analysis processing executed in the analysis environment 132 to the report generator 141.

Next, the report generator 141 generates the report as the output information in response to the input information. Any method may be used for generating the output information. For example, the report generator 141 inputs, to the language model such as the LLM, the input information, the result of the analysis processing, and an instruction to explain to the user based on the result of the analysis processing, and acquires an explanatory text describing the analysis result from the LLM.

An example of a prompt for generating the explanatory text describing the result of the analysis processing using the LLM is as follows.

### Example of Prompt

The following execution result is obtained for the instruction below. Please create a text describing this result.

### Instruction

Tell me data items that are strongly correlated with quality.

### Execution Result

Correlation coefficient with quality

Melting temperature 0.74

Torque value 0.63

Cycle time 0.07

Furthermore, for example, the report generator 141 generates the report by customizing a template prepared in advance or filling a placeholder prepared in advance. Specifically, for example, the report generator 141 generates the report by applying the input information and the result of the analysis processing to the template.

The report generator 141 inputs the generated report to the output unit 15, and the report is provided from the output unit 15 to the user.

The report may include not only a description of the result of the analysis processing but also an analysis content, a proposal of an action to be performed next, and the like.

In addition, an arbitrary prompt engineering method such as giving examples of a case where the abstraction level is high and a case where the abstraction level is low may be used for the prompt when determining the abstraction level by using the language model.

Further, information such as a data item name of data to be analyzed may be used when determining the abstraction level.

In addition, when any error occurs in the analysis environment 132, the analysis management unit 131 may attempt to repair the error. For example, when a library required for executing the source code is insufficient in the analysis environment 132, the analysis management unit 131 may issue an instruction to dynamically install a necessary library in the analysis environment 132.

Furthermore, for example, in a case where there is some incompleteness in the source code, the analysis management unit 131 may input, to the language model, the source code, an error message, and an instruction to correct the source code, and may acquire the updated source code. Furthermore, in a case where it is determined that the repair by the analysis management unit 131 is difficult, the analysis planning unit 121 may make a plan again. For example, the analysis planning unit 121 may make a plan different from the failed plan by considering the already failed plan.

Furthermore, the analysis planning unit 121 may make a plan regarding the analysis environment 132. For example, a computer resource required by the analysis processing to be executed varies. The analysis planning unit 121 may request the analysis management unit 131 for an appropriate calculation resource for each analysis processing. The calculation resource includes the number and usage rates of central processing units (CPUs), graphics processing units (GPUs), memories, or the like.

Furthermore, for example, the analysis planning unit 121 may request the analysis management unit 131 for a virtual machine for executing the analysis processing. Furthermore, for example, the analysis planning unit 121 may select a container for executing the analysis processing, and request the analysis management unit 131 for the selected container. Furthermore, for example, the analysis planning unit 121 may request the analysis environment 132 based on a design document by inputting the design document for executing the analysis processing to the analysis management unit 131.

Furthermore, the analysis planning unit 121 may prepare a plurality of analysis processing candidates. For example, the analysis planning unit 121 may provide the optimal result of the analysis processing as a response by sequentially executing the analysis processing candidates and evaluating validity of the result of the analysis processing. Furthermore, for example, the analysis planning unit 121 may prepare an analysis plan in which all analysis processing results of the analysis processing candidates are provided as a response to the user.

Furthermore, for example, the analysis planning unit 121 may prepare an analysis plan in which the plurality of analysis processing candidates are executed in parallel by a plurality of processes, and a response is immediately provided to the user in order of completion of the analysis processing.

### Second Example of Information Processing

Next, a second example of the information processing according to the first embodiment will be described. In the second example of the information processing, an operation in a case where it is determined that the input information is insufficient (in a case where it is determined by the LLM that the abstraction level of the natural language included in the input information is high) will be described.

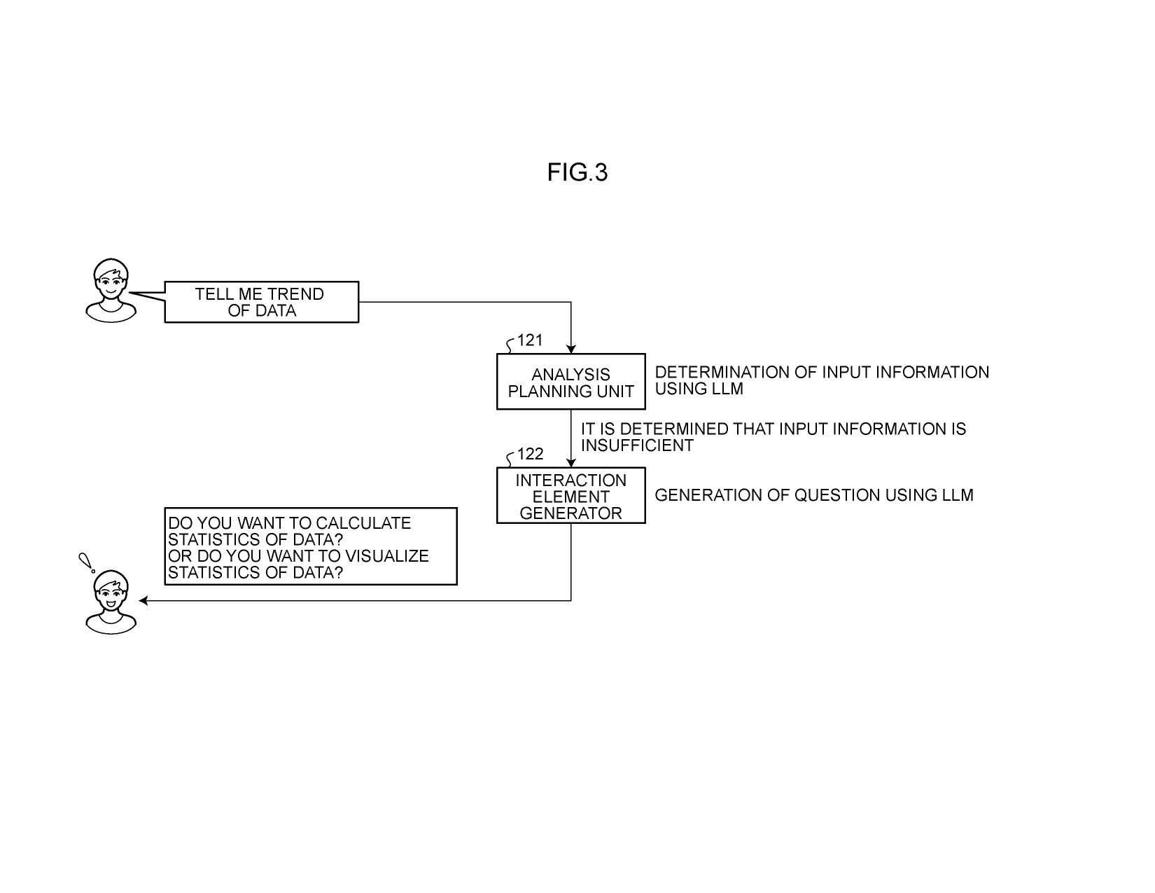

FIG. 3 is a diagram for describing the second example of the information processing according to the first embodiment. In the example of FIG. 3, the input receiver 11 receives, from the user, the input information expressed in the natural language, "Tell me the trend of the data". "Tell me the trend of the data" is an example of the input information with an ambiguous intention of the user.

The input receiver 11 inputs the input information to the analysis planning unit 121.

Next, the analysis planning unit 121 determines whether or not the input information includes information sufficient for planning the analysis processing by using the language model such as the LLM.

An example of a prompt for determining whether or not the input information is sufficient by using the LLM is as follows.

### Example of Prompt

Please determine whether the abstraction level of the following instruction is high.

### Instruction

Tell me the trend of the data

In a case where it is determined by using the LLM that the abstraction level is high, the analysis planning unit 121 inputs the input information to the interaction element generator 122.

The interaction element generator 122 generates the interaction element for acquiring the input information necessary for specifying the analysis processing. Any method may be used for generating the interaction element. In the first embodiment, the interaction element generator 122 inputs the input information and an instruction to generate a question sentence (an example of the interaction element) to the language model such as the LLM, and causes the language model to generate the question sentence for the user.

An example of a prompt for generating the source code using the LLM is as follows.

### Example of Prompt

Please create a question for the user to obtain information necessary for generating a Python code that executes the following instruction

### Instruction

Tell me the trend of the data

### Example of Generation of Question Sentence

Do you want to calculate the statistics of the data?

Or do you want to visualize the statistics of the data?

The output unit 15 outputs the question sentence generated by the language model to present the question sentence to the user.

The interaction element is not limited to the question sentence. For example, the interaction element may be a message that presents a plurality of candidates and prompts the user to select one of the candidates. Furthermore, for example, the interaction element may be a message that requests the user to confirm execution of the tentatively planned analysis processing in advance because a language expression of the user is determined to have an unclear intention.

Furthermore, for example, the interaction element generator 122 may acquire the interaction history from the interaction history DB 101 and input the interaction history to the language model such as the LLM so that a context of the questions and the answers can be grasped. As a result, the interaction element generator 122 can generate the interaction element further based on the context specified by the interaction history.

As described above, in the information processing apparatus 1 according to the first embodiment, the input receiver 11 receives the input information expressed in the natural language from the user. The analysis planning unit 121 determines the abstraction level of the natural language included in the input information by using the language model, and plans the analysis processing intended by the user by using the natural language in a case where it is determined by the language model that the abstraction level is low. In a case where it is determined by the language model that the abstraction level is high, the interaction element generator 122 generates the interaction element that more specifically specifies the intention of the user expressed in the natural language included in the input information. In a case where it is determined by the language model that the abstraction level is low, the analysis determiner 123 determines the execution method for the planned analysis processing. The analysis execution unit 13 executes the analysis processing by the determined execution method. The output generator 14 generates the output information based on the result of the analysis processing. Then, the output unit 15 outputs the interaction element or the output information.

As a result, with the information processing apparatus 1 according to the first embodiment, the data analysis can be more effectively supported. Specifically, the data analysis can be more effectively supported by prompting mutual information transmission between the user and the information processing apparatus 1.

### Second Embodiment

Next, a second embodiment will be described. In a description of the second embodiment, a description of the same content as that according to the first embodiment is omitted, and only differences from the first embodiment will be described. In the second embodiment, processing of determining analysis processing by referring to analysis processing information defined in advance will be described.

### Example of Functional Configuration

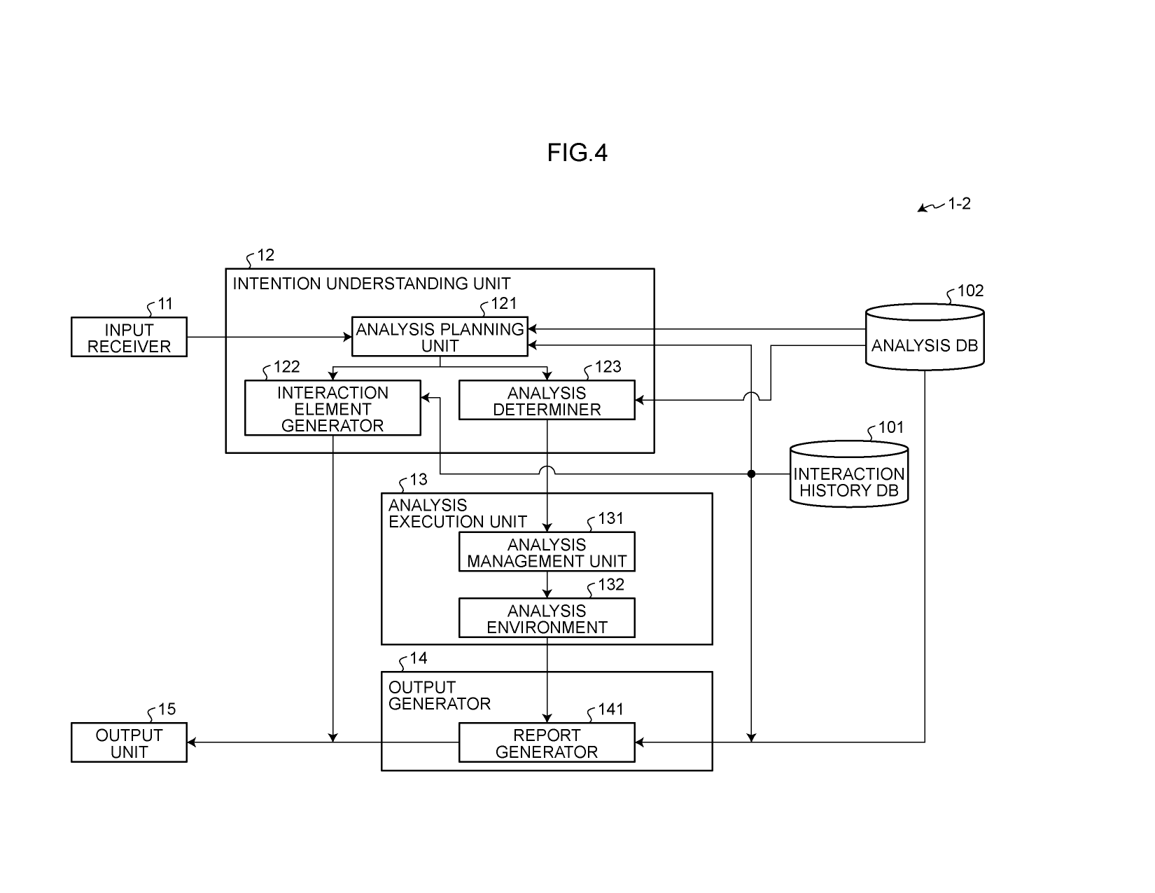

FIG. 4 is a diagram illustrating an example of a functional configuration of an information processing apparatus 1-2 according to the second embodiment. A storage device of the information processing apparatus 1-2 according to the second embodiment further stores an analysis DB 102 therein.

The analysis DB 102 stores therein one or more pieces of analysis processing information defined in advance. The analysis processing information includes a name of the analysis processing, an execution content (explanatory information) of the analysis processing, and a description regarding a parameter required at the time of executing the analysis. Further, the analysis processing information may further include a source code associated with the analysis processing.

### Example of Information Processing

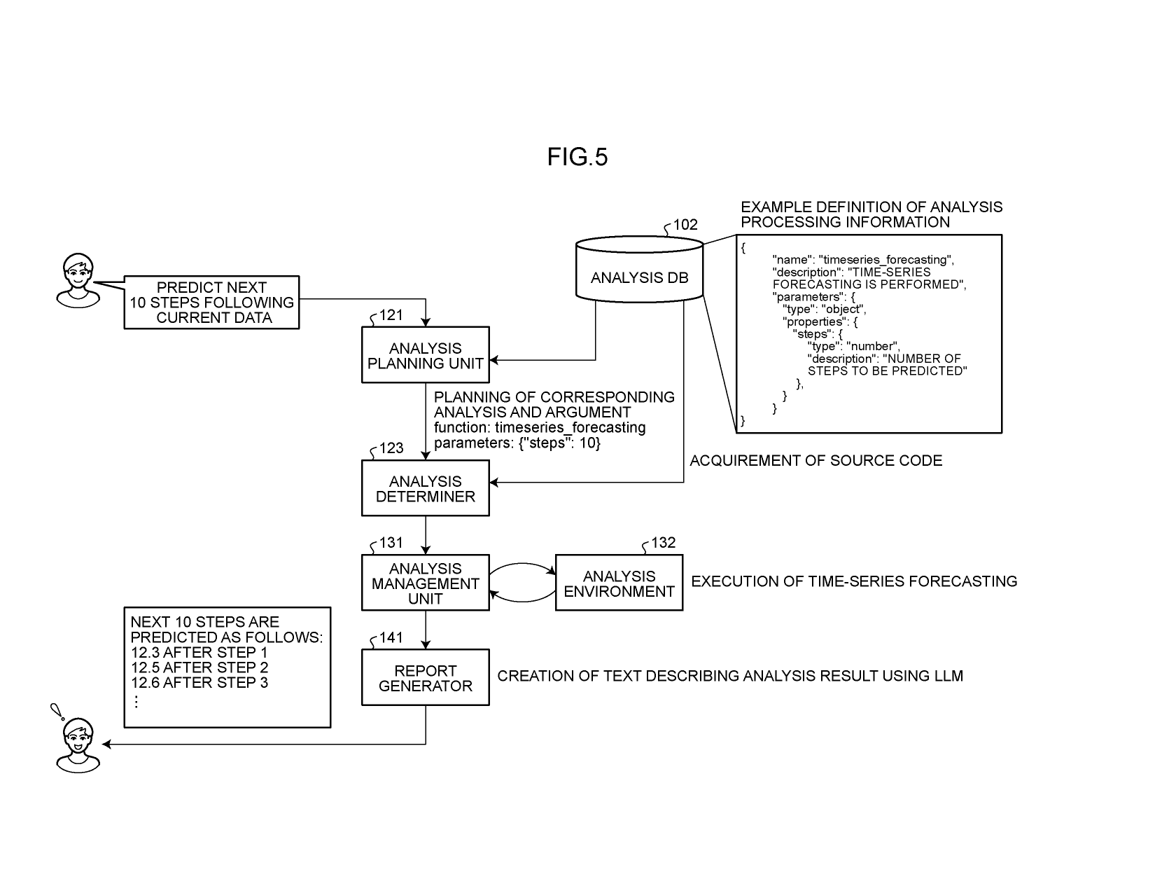

FIG. 5 is a diagram for describing an example of information processing according to the second embodiment. In the example of FIG. 5, a case where the analysis DB 102 stores therein the analysis processing information for time-series forecasting in advance will be described as an example. In the example of FIG. 5, an input receiver 11 receives, from the user, input information expressed in natural language, "Predict the next 10 steps following the current data".

Next, an analysis planning unit 121 collates the input information with the analysis processing information stored in the analysis DB 102. Any method may be used for collating the input information with the analysis processing information.

For example, the analysis planning unit 121 may input one or more pieces of analysis processing information stored in the analysis DB 102 and the input information to a language model, and acquire a collation result from the language model.

Furthermore, for example, the analysis planning unit 121 may input one or more pieces of analysis processing information stored in the analysis DB 102 and the input information to an embedded model, and collate the input information with the analysis processing information based on a similarity between two vectors (nearest-neighbor search in a vector space) obtained from the embedded model. That is, the analysis planning unit 121 may convert the input information into a first vector, convert one or more pieces of analysis processing information into one or more second vectors, respectively, and collate the input information with the one or more pieces of analysis processing information based on a similarity between the first vector and each of the one or more second vectors.

At least a part of the analysis processing information and at least a part of the input information are input to the embedded model.

Furthermore, for example, the analysis planning unit 121 may collate the input information with the analysis processing information by performing pattern matching between a keyword included in the input information and information associated with one or more pieces of analysis processing information, which is included in the analysis processing information. For example, the information associated with one or more pieces of analysis processing information is a character string indicating a content of the analysis processing, a keyword, or the like.

The analysis planning unit 121 specifies the analysis processing most related to the input information by the collation, and plans an argument (parameter) to be used in the analysis processing. In the example of FIG. 5, a parameter indicating a step is set to 10 for the prediction of 10 steps. In this way, in a case where the analysis processing to be executed and the requested parameter are specified, it is determined that the abstraction level is low, and such pieces of information are transmitted to an analysis determiner 123.

Next, the analysis determiner 123 determines an execution method for the analysis processing planned by the analysis planning unit 121. For example, in a case where the source code associated with the planned analysis processing is defined in the analysis DB 102 in advance, the analysis determiner 123 acquires the source code from the analysis DB 102.

Furthermore, for example, in a case where the source code associated with the planned analysis processing is not defined in the analysis DB 102 in advance, the analysis determiner 123 causes the language model such as an LLM to generate the source code, similarly to the first example of the information processing according to the first embodiment described above.

The analysis determiner 123 inputs the source code to an analysis management unit 131.

The subsequent processing is similar to that in the first example of the information processing described above. Note that an example of a prompt based on which a report generator 141 causes the language model such as the LLM to generate a text describing an analysis result is as follows.

### Example of Prompt

The following execution result is obtained for the instruction below. Please create a text describing this result.

### Instruction

Predict the next 10 steps following the current time-series data

### Execution Result

12.3 after Step 1

12.5 after Step 2

12.6 after Step 3

The report generator 141 may read the explanatory information of the executed analysis processing from the analysis DB 102 described above, and generate the report based on the explanatory information.

In the example of the information processing according to the second embodiment described above, for example, in a case where the input information is "Perform time-series forecasting", even if the analysis planning unit 121 can specify that the analysis processing information of the time-series forecasting of the analysis DB 102 is the most related information, the number of forecasting steps, which is the argument (parameter) of the analysis processing, cannot be specified.

In this way, in a case where the argument cannot be specified, it is determined that the abstraction level is high, and an interaction element generator 122 generates an interaction element for specifying the parameter of the analysis processing of the time-series forecasting and presents the interaction element to the user through an output unit 15. Then, the input receiver 11 further receives, from the user, the input information for specifying the number of forecasting steps, which is the argument (parameter).

### Third Embodiment

Next, a third embodiment will be described. In a description of the third embodiment, a description of the same content as that according to the second embodiment is omitted, and only differences from the second embodiment will be described. In the third embodiment, processing of understanding an intention of the user based on supplemented input information and determining appropriate analysis processing will be described.

### Example of Functional Configuration

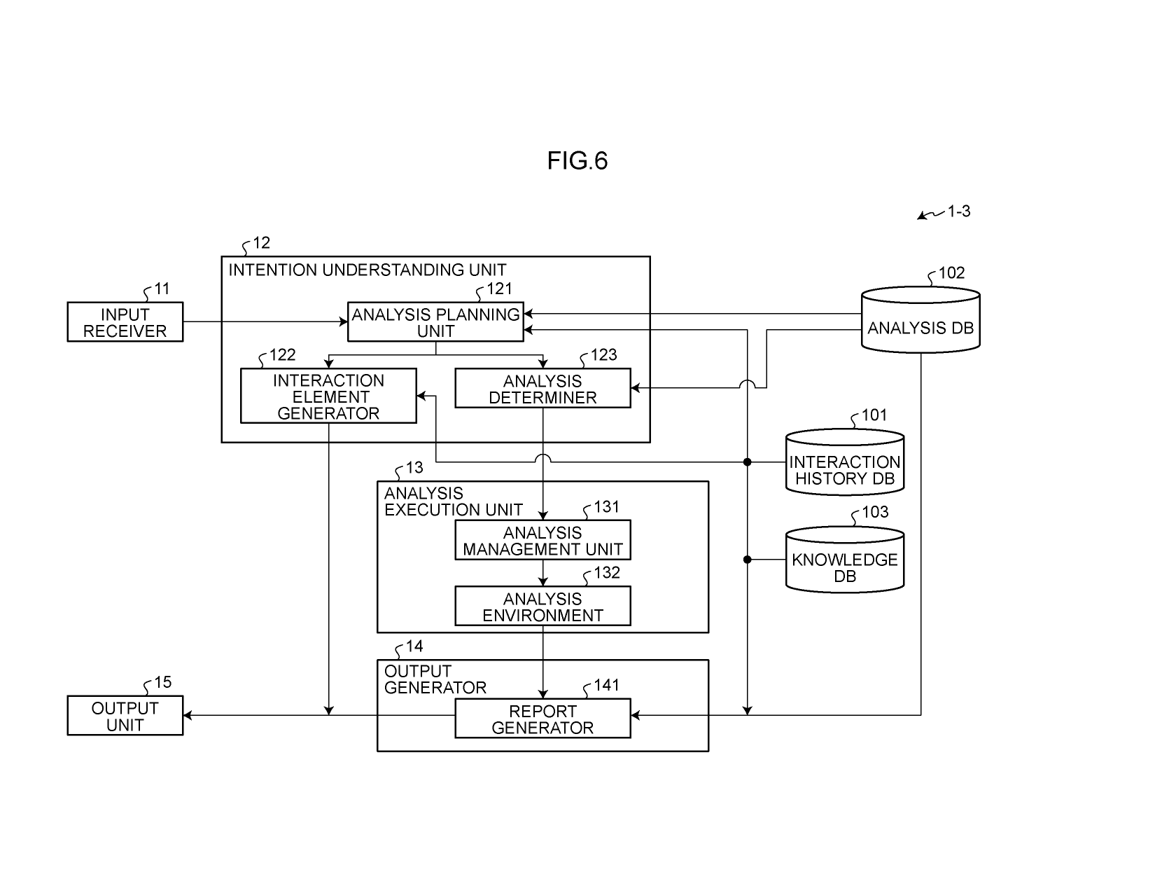

FIG. 6 is a diagram illustrating an example of a functional configuration of an information processing apparatus 1-3 according to the third embodiment. A storage device of the information processing apparatus 1-3 according to the third embodiment further stores a knowledge DB 103 therein.

The knowledge DB 103 stores therein knowledge information that supplements the input information. The knowledge information is used to more specifically identify an ambiguous element that affects analysis processing, output processing, and the like.

An analysis planning unit 121 supplements a natural language included in the input information based on the knowledge information, and determines an abstraction level of the supplemented natural language. Then, in a case where it is determined by a language model that the abstraction level is low, the analysis planning unit 121 plans the analysis processing by the supplemented natural language.

### Example of Information Processing

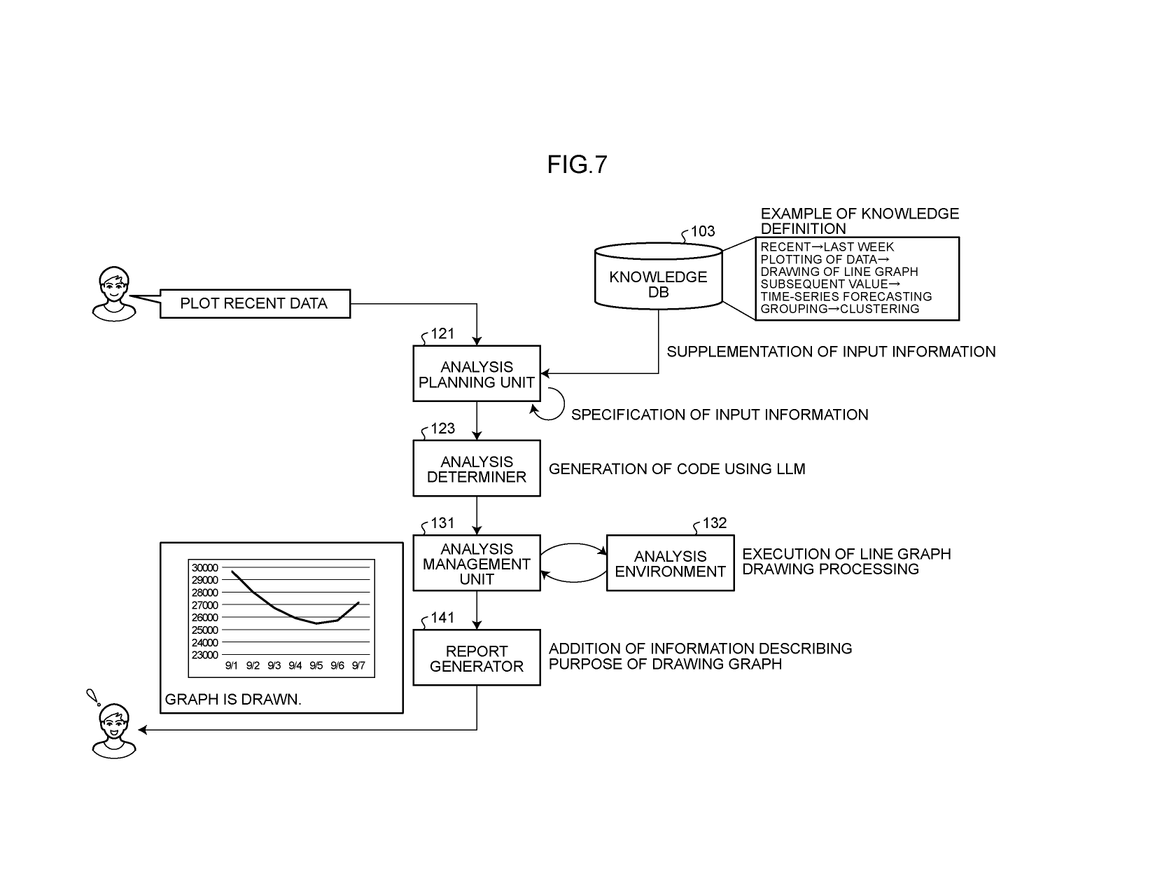

FIG. 7 is a diagram for describing an example of information processing according to the third embodiment. In the example of FIG. 7, an input receiver 11 receives, from the user, the input information expressed in the natural language, "Plot the recent data".

The expressions "recent" and "plot the data" are examples of language expressions whose definitions are ambiguous. For example, the input information can be supplemented by registering, in the knowledge DB 103, knowledge information indicating that the expression "recent" means "the last week" and knowledge information indicating that the expression "plotting the data" means "drawing a line graph".

That is, the analysis planning unit 121 plans specific analysis processing of "drawing a line graph of the last week" by supplementing the input information with reference to the knowledge DB 103. Specifically, in a case where the last week is from September 1 to September 7, the analysis processing including processing of drawing a line graph corresponding to a period from September 1 to September 7 is planned.

Any method may be used for collating the input information with the knowledge information. For example, the knowledge DB 103 may store a dictionary in which a specific keyword or phrase that can be used by the user is a key, and information that specifically supplements the specific keyword or phrase is a value. In this case, the analysis planning unit 121 collates the input information with the knowledge information by performing character string pattern matching between the specific phrase extracted from the input information and the key of the dictionary.

Furthermore, for example, the knowledge DB 103 may store the specific keyword or phrase that can be used by the user and the information that specifically supplements the specific keyword or phrase in a vector DB. In this case, the analysis planning unit 121 collates the input information with the knowledge information by performing vector search on the vector DB using the specific phrase extracted from the input information as a query.

Next, an analysis determiner 123 determines an analysis method for responding to the input information. Any method may be used for determining the analysis method. In the third embodiment, the analysis determiner 123 inputs, to the language model such as an LLM, the input information and an instruction to generate a source code for generating output information according to the input information, and acquires the source code from the language model.

An example of a prompt for generating the source code using the LLM is as follows.

### Example of Prompt

Please create a Python code that executes the following instruction.

### Instruction

Draw a line graph corresponding to a period from September 1 to September 7

The analysis determiner 123 inputs the source code output from the LLM to an analysis management unit 131.

Next, the analysis management unit 131 creates an analysis environment 132 for executing the source code, instructs the analysis environment 132 to execute the source code, and performs monitoring. The analysis management unit 131 inputs a result of the analysis processing (processing of drawing a line graph in the example of FIG. 7) executed in the analysis environment 132 to a report generator 141.

Next, the report generator 141 generates a report as the output information in response to the input information. Any method may be used for generating the output information. For example, the report generator 141 generates the report including the result (the line graph in the example of FIG. 7) of the analysis processing and information describing the purpose of drawing the graph. The report generator 141 may input the analysis processing result including the graph to a multimodal model and cause the multimodal model to generate a description of the graph.

### Fourth Embodiment

Next, a fourth embodiment will be described. In a description of the fourth embodiment, a description of the same content as that according to the third embodiment is omitted, and only differences from the third embodiment will be described. In the fourth embodiment, processing in a case where an output generator 14 generates a report element by using a multimodal model will be described.

### Example of Functional Configuration

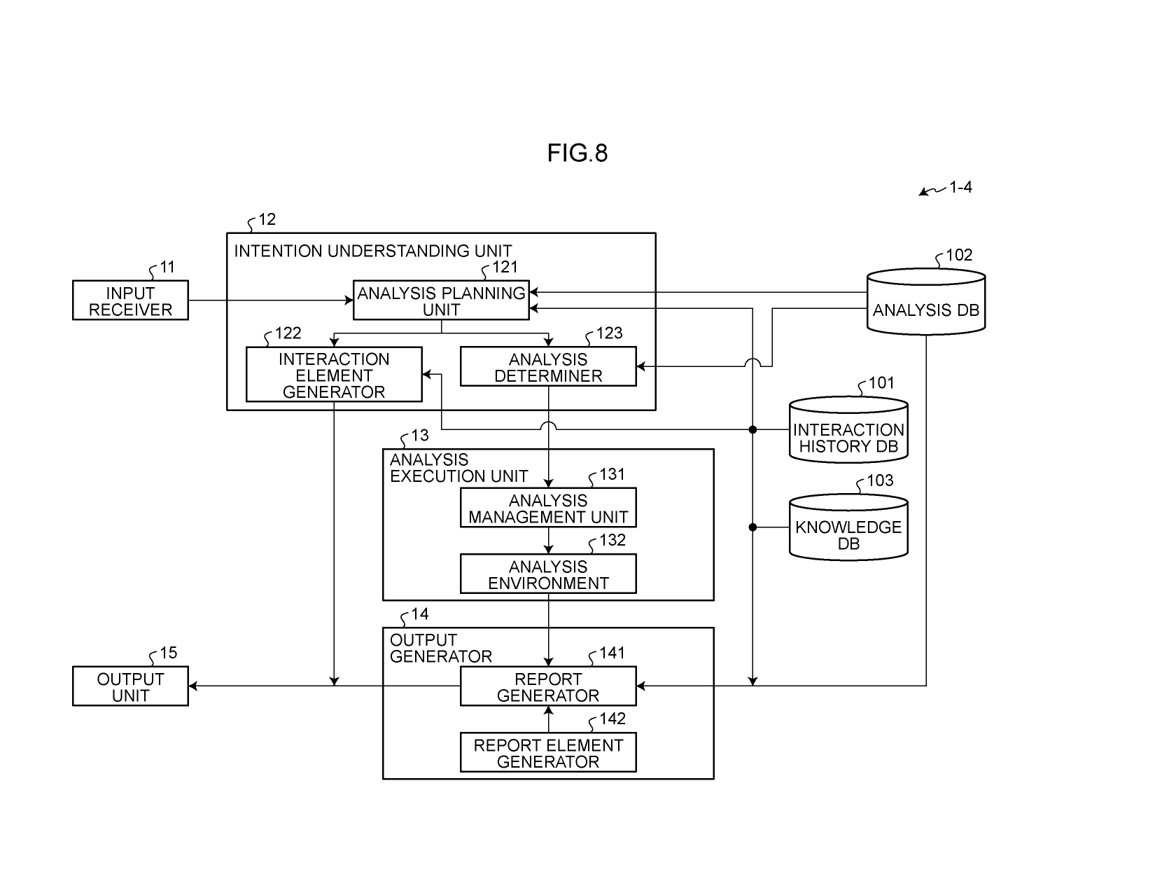

FIG. 8 is a diagram illustrating an example of a functional configuration of an information processing apparatus 1-4 according to the fourth embodiment. The output generator 14 of the information processing apparatus 1-4 according to the fourth embodiment further includes a report element generator 142.

A report generator 141 according to the fourth embodiment generates a report including the report element generated by the report element generator 142.

The report element generator 142 generates the report element to be included in the report. The report element includes at least one of a description of a result of analysis processing, a content of the analysis processing, and a proposal based on the result of the analysis processing.

### Example of Information Processing

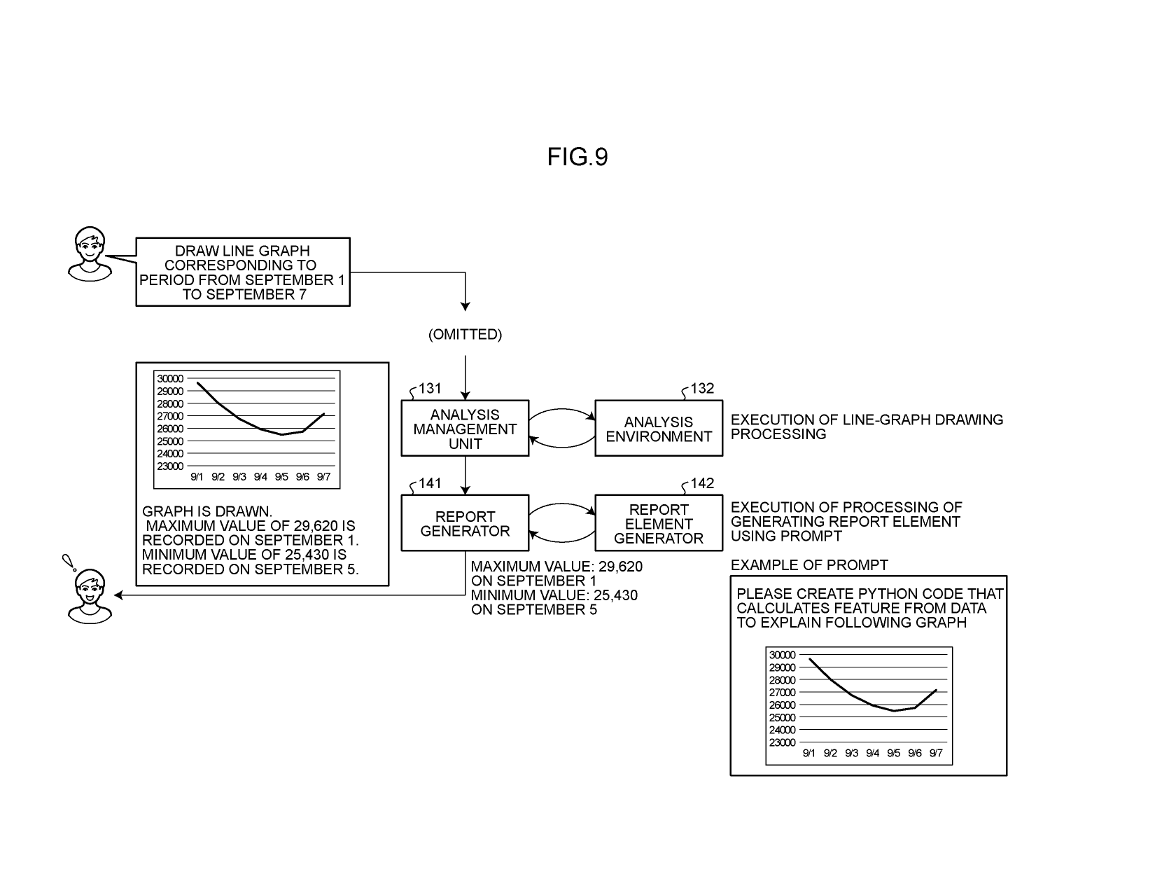

FIG. 9 is a diagram for describing an example of information processing according to the fourth embodiment. In the example of FIG. 9, an input receiver 11 receives, from the user, input information expressed in a natural language, "Draw a line graph corresponding to a period from September 1 to September 7".

In the example of FIG. 9, the input information is processed in the same manner as in the above-described third embodiment, and line graph drawing processing is executed in an analysis environment 132.

Next, the report generator 141 instructs the report element generator 142 to generate the report element.

Next, the report element generator 142 executes report element generation processing by using a prompt, for example, as in the example of the prompt illustrated in FIG. 9. Specifically, in a case where the graph is included in an output result of the analysis processing, the report element generator 142 inputs, to the multimodal model, an instruction to generate a code for calculating feature values of the graph as a description of the graph. For example, the feature values may include a maximum value, a minimum value, or the like in the line graph.

The report element generator 142 passes an execution result of the code output from the multimodal model to the report generator 141. The report generator 141 generates the report by using the feature values.

According to the fourth embodiment, it is possible to perform control to focus on specific feature values or to improve accuracy of a numerical value as compared with a case where an image of a graph is directly input into the multimodal model to generate an explanatory text.

### Fifth Embodiment

Next, a fifth embodiment will be described. In a description of the fifth embodiment, a description of the same content as that according to the third embodiment is omitted, and only differences from the third embodiment will be described. In the fifth embodiment, processing in a case where information is searched based on input information will be described.

### Example of Functional Configuration

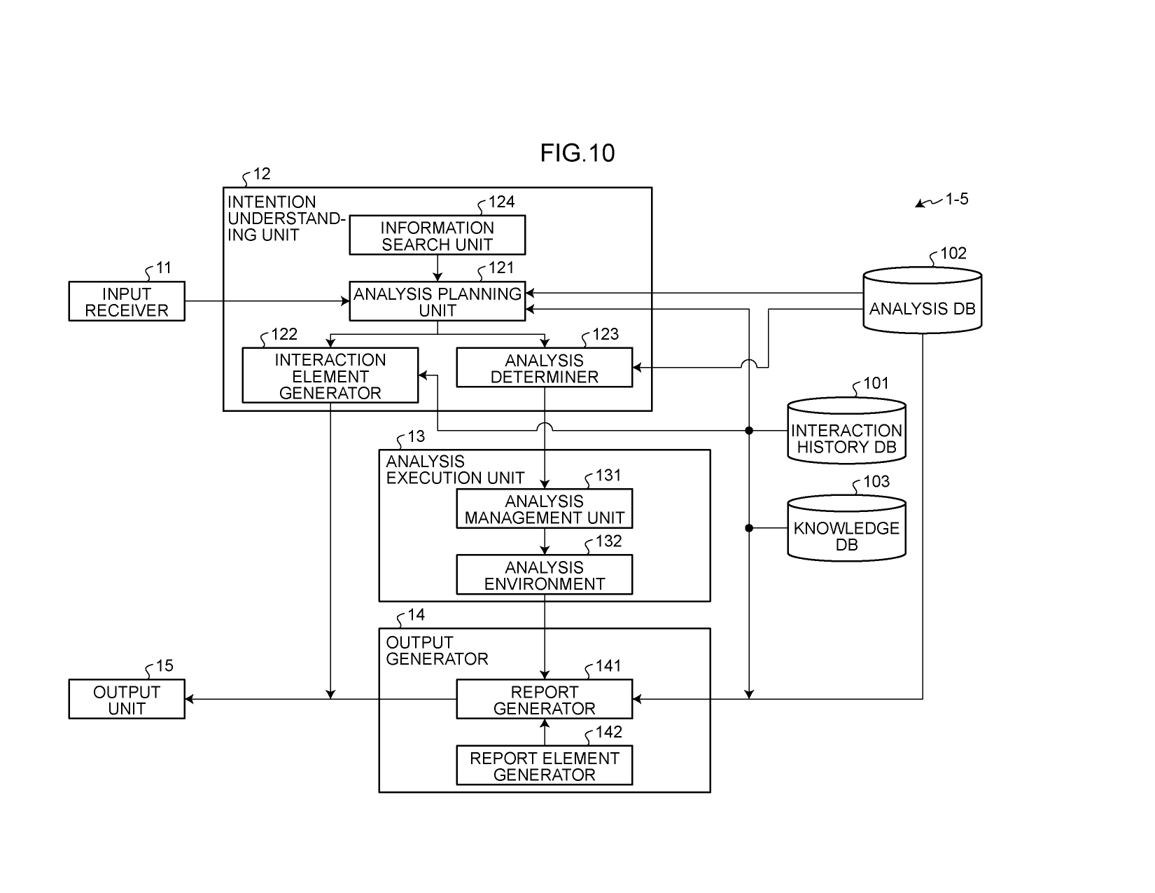

FIG. 10 is a diagram illustrating an example of a functional configuration of an information processing apparatus 1-5 according to the fifth embodiment. An intention understanding unit 12 of the information processing apparatus 1-5 according to the fifth embodiment further includes an information search unit 124.

The information search unit 124 searches for related information corresponding to the input information. Specifically, the information search unit 124 searches for information from information sources such as information disclosed on the Internet, an existing document file group, an e-mail, and a chat. For example, the information search unit 124 searches for information highly related to the input information or searches for information related to data to be analyzed.

As the information sources, data such as an existing file group may be used as it is, and processed data may be used. Specifically, an information source generated by dividing or summarizing contents of a file may be used. Furthermore, for example, an information source obtained by extracting information as a knowledge graph from an existing file group or the like may be used.

### Example of Information Processing

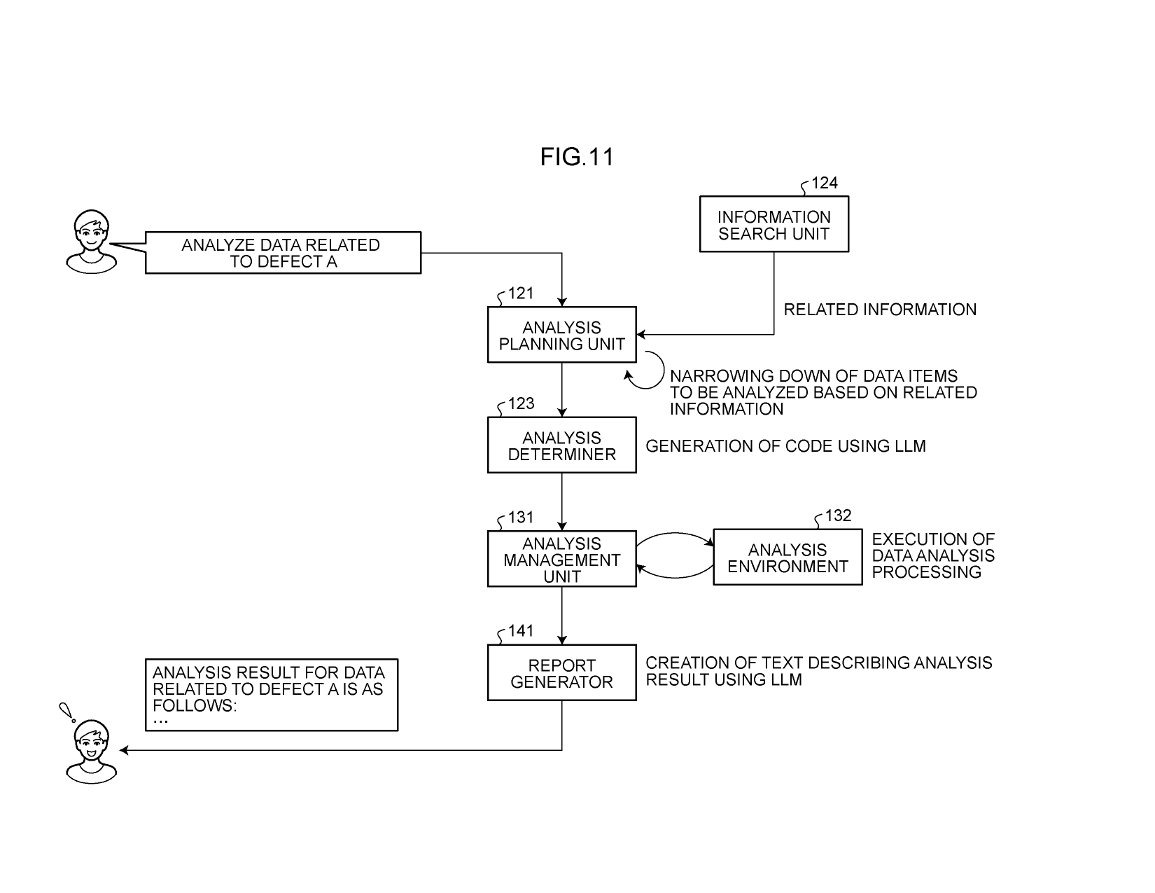

FIG. 11 is a diagram for describing an example of information processing according to the fifth embodiment. In the example of FIG. 11, an input receiver 11 receives, from the user, the input information expressed in a natural language, "Analyze the data related to defect A".

Next, the information search unit 124 searches for information from the information source by using the input information, a keyword extracted from the input information, a summary of an input text, or the like as a query.

Any method may be used for searching for the information from the information source. For example, the information may be searched from the information source by keyword search between a query and each element of the information source. Furthermore, for example, the query and each element of the information source may be vectorized, and the information may be searched from the information source by vector search using a similarity between the vectors.

Furthermore, for example, in a case where the information source is a knowledge graph, a search method of specifying a node of the graph related to the input information by keyword matching, vector search, or the like, and extracting information of another node associated with the node may be used.

By the above search method, the information search unit 124 searches for the information related to the input information. The searched information is used by any one or more of an analysis planning unit 121, an interaction element generator 122, an analysis determiner 123, and a report generator 141.

For example, in the example of FIG. 11, if the information searched by the information search unit 124 includes related information regarding an element that is a cause candidate of defect A, the analysis planning unit 121 makes an analysis plan in which data items to be analyzed are narrowed down to the cause candidate of defect A based on the related information.

Since processing after the analysis determiner 123 is similar to the processing in the above-described third embodiment, a description thereof will be omitted.

Instead of the analysis planning unit 121, the analysis determiner 123 may narrow down the data items to be analyzed at a stage of code generation or the like. That is, the analysis planning unit 121 or the analysis determiner 123 may perform data analysis by narrowing down the data items to data items strongly related to the input information based on the searched related information.

In addition, if the searched related information includes information such as an analysis method and an algorithm effective for responding to the input information, the analysis method, the algorithm, and the like may be determined based on the information.

Furthermore, the interaction element generator 122 may use the related information searched by the information search unit 124. For example, the interaction element generator 122 may specify the data items related to defect A based on the related information searched by the information search unit 124, and generate an interaction element for asking the user which data item is desired to be analyzed among the specified data items.

In addition, the report generator 141 may use the related information searched by the information search unit 124. For example, the report generator 141 may compare a content found from a data analysis result with the related information searched by the information search unit 124 to explain validity of the analysis result or to give a supplementary explanation of the analysis result. Furthermore, for example, the report generator 141 may make some suggestions to the user based on the analysis result and the related information. Furthermore, for example, the information search unit 124 may search the information source using information included in the data analysis result or a description generated based on the analysis result as a query, and the search result may be used by the report generator 141 to provide a description regarding the analysis result or some suggestions to the user.

As described above, in the information processing apparatus 1-5 according to the fifth embodiment, the information search unit 124 searches for the related information related to at least one of the input information, information regarding the result of the analysis processing, and explanatory information generated based on the information regarding the result of the analysis processing. The related information is used for at least one of processing of planning the analysis processing by the analysis planning unit 121, processing of generating the interaction element by the interaction element generator 122, processing of determining an execution method for the analysis processing by the analysis determiner 123, and processing of generating output information by an output generator 14.

As a result, according to the fifth embodiment, by reflecting the related information searched by the information search unit 124 in a data analysis content, the description of the analysis result, and the like, it is possible to further improve validity of the analysis content, persuasiveness of the description of the analysis result, and the like.

Finally, an example of a hardware configuration of the information processing apparatuses 1 to 1-5 according to the first to fifth embodiments will be described.

### Example of Hardware Configuration

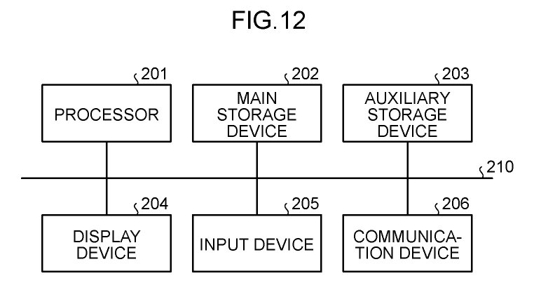

FIG. 12 is a diagram illustrating an example of a hardware configuration of the information processing apparatuses 1 to 1-5 according to the first to fifth embodiments. The information processing apparatuses 1 to 1-5 according to the first to fifth embodiments each include a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected via a bus 210.

Note that the information processing apparatuses 1 to 1-5 according to the first to fifth embodiments do not have to include a part of the above configuration. For example, in a case where the information processing apparatuses 1 to 1-5 of the first to fifth embodiments can use an input function and a display function of an external apparatus, the information processing apparatuses 1 to 1-5 of the first to fifth embodiments do not have to include the display device 204 and the input device 205.

The processor 201 executes a program read from the auxiliary storage device 203 to the main storage device 202. The main storage device 202 is a memory such as a read only memory (ROM) or a random access memory (RAM). The auxiliary storage device 203 is a hard disk drive (HDD), a memory card, or the like.

The display device 204 is, for example, a liquid crystal display. The input device 205 is an interface for operating the information processing apparatuses 1 to 1-5 according to the first to fifth embodiments. The display device 204 and the input device 205 may be implemented by a touch panel or the like having a display function and an input function. The communication device 206 is an interface for communicating with other apparatuses.

For example, a program executed by the information processing apparatuses 1 to 1-5 according to the first to fifth embodiments is a file in an installable format or an executable format, is recorded in a computer-readable storage medium such as a memory card, a hard disk, a CD-RW, a CD-ROM, a CD-R, a DVD-RAM, or a DVD-R, and is provided as a computer program product.

Furthermore, for example, the program executed by the information processing apparatuses 1 to 1-5 according to the first to fifth embodiments may be stored on a computer connected to a network such as the Internet and provided by being downloaded via the network.

Furthermore, for example, the program executed by the information processing apparatuses 1 to 1-5 according to the first to fifth embodiments may be provided via the network such as the Internet without being downloaded. Specifically, the processing in the information processing apparatuses 1 to 1-5 of the first to fifth embodiments may be executed by a so-called application service provider (ASP) type service that implements a processing function only by an execution instruction and result acquisition without transferring the program from a server computer.

Furthermore, for example, the program of the information processing apparatuses 1 to 1-5 according to the first to fifth embodiments may be provided by being incorporated in the ROM or the like in advance.

The program executed by the information processing apparatuses 1 to 1-5 according to the first to fifth embodiments has a module configuration including a function that can be implemented by the program among the above-described functional configurations. As actual hardware, the processor 201 reads the program from the storage medium and executes the program, whereby the functional blocks are loaded on the main storage device 202. That is, the respective functional blocks are generated on the main storage device 202.

Note that some or all of the functions described above may be implemented by hardware such as an integrated circuit (IC) instead of being implemented by software.

In addition, the respective functions may be implemented by using a plurality of processors 201, and in this case, each processor 201 may implement one of the functions or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
one or more hardware processors configured to function as:
an input receiver that receives input information expressed in a natural language from a user;
an analysis planning unit that determines an abstraction level of the natural language by using a language model, and plans analysis processing intended by the user by using the natural language in a case where it is determined by the language model that the abstraction level is low;
an interaction element generator that generates an interaction element that more specifically specifies an intention of the user expressed in the natural language in a case where it is determined by the language model that the abstraction level is high;
an analysis determiner that determines an execution method for planned analysis processing in a case where it is determined by the language model that the abstraction level is low;
an analysis execution unit that executes the analysis processing by the determined execution method;
an output generator that generates output information based on a result of the analysis processing; and
an output unit that outputs the interaction element or the output information.

2. The information processing apparatus according to claim 1, wherein the analysis determiner generates a program for executing the planned analysis processing using the natural language by using the language model.

3. The information processing apparatus according to claim 1, wherein
the one or more hardware processors are configured to further function as:
storage that stores therein analysis processing information including one or more pieces of analysis processing information defined in advance,
the analysis planning unit collates the input information with the one or more pieces of analysis processing information, and
the analysis determiner determines, based on the natural language, the execution method for the analysis processing collated based on the input information.

4. The information processing apparatus according to claim 3, wherein
the analysis processing information includes a keyword associated with each of the one or more pieces of analysis processing information, and
the analysis planning unit collates the input information with the one or more pieces of analysis processing information by performing pattern matching between a keyword extracted from the input information and the keyword associated with the analysis processing.

5. The information processing apparatus according to claim 3, wherein
the analysis planning unit converts the input information into a first vector, converts the one or more pieces of analysis processing information into one or more second vectors respectively, and collates the input information with the one or more pieces of analysis processing information based on a similarity between the first vector and each of the one or more second vectors.

6. The information processing apparatus according to claim 3, wherein
the analysis planning unit inputs the input information and the analysis processing information to the language model, and causes the language model to collate the input information with the one or more pieces of analysis processing information.

7. The information processing apparatus according to claim 3, wherein
the analysis determiner generates a program for executing the analysis processing collated based on the input information, from the collated analysis processing by using the language model.

8. The information processing apparatus according to claim 1, wherein
the analysis planning unit further plans an analysis environment that is an environment in which the analysis processing is executed according to the planned analysis processing.

9. The information processing apparatus according to claim 8, wherein
the analysis planning unit plans the analysis environment in which a plurality of analysis processing candidates are executed in parallel by a plurality of processes in a case where the planned analysis processing includes the plurality of analysis processing candidates.

10. The information processing apparatus according to claim 1, wherein
the output generator includes a report generator that generates a report by applying the result of the analysis processing to a template and generates the report as the output information.

11. The information processing apparatus according to claim 1, wherein
the output generator includes a report generator that generates a report based on the result of the analysis processing by using the language model, and generates the report as the output information.

12. The information processing apparatus according to claim 11, wherein
the language model is a multimodal model, and
in a case where the result of the analysis processing includes a graph, the report generator generates the report including a description of the graph based on the graph by the multimodal model.

13. The information processing apparatus according to claim 1, wherein
the output generator includes a report element generator that generates a report element included in a report, and
the output unit outputs the report as the output information.

14. The information processing apparatus according to claim 13, wherein
in a case where the result of the analysis processing includes a graph, the report element generator generates the report including a description of the graph as the report element based on the graph by using a multimodal model.

15. The information processing apparatus according to claim 13, wherein
the report element includes at least one of a description of the result of the analysis processing, a content of the analysis processing, and a proposal based on the result of the analysis processing.

16. The information processing apparatus according to claim 3, wherein
the analysis processing information includes explanatory information of one or more pieces of the analysis processing information, and
the output generator includes a report generator that generates a report based on the explanatory information of the executed analysis processing.

17. The information processing apparatus according to claim 1, wherein
the one or more hardware processors are configured to further function as:
storage that stores therein knowledge information that supplements the natural language, and
the analysis planning unit supplements the natural language based on the knowledge information, determines an abstraction level of the supplemented natural language by using the language model, and plans the analysis processing using the supplemented natural language in a case where it is determined by the language model that the abstraction level is low.

18. The information processing apparatus according to claim 1, wherein
the one or more hardware processors are configured to further function as:
an information search unit that searches for related information related to at least one of the input information, information regarding the result of the analysis processing, and explanatory information generated based on the information regarding the result of the analysis processing, and
the related information is used for at least one of processing of planning the analysis processing by the analysis planning unit, processing of generating the interaction element by the interaction element generator, processing of determining an execution method for the analysis processing by the analysis determiner, and processing of generating the output information by the output generator.

19. The information processing apparatus according to claim 18, wherein
the information search unit searches for the related information from an information source represented by a knowledge graph.

20. The information processing apparatus according to claim 1, wherein
the one or more hardware processors are configured to further function as:
storage that stores therein an interaction history with the user, and
the interaction element generator generates the interaction element further based on a context specified by the interaction history in a case where it is determined by the language model that the abstraction level is high.

21. An information processing method, comprising:
receiving, by an information processing apparatus comprising one or more hardware processors, input information expressed in a natural language from a user;
determining, by the information processing apparatus, an abstraction level of the natural language by using a language model, and planning analysis processing intended by the user by using the natural language in a case where it is determined by the language model that the abstraction level is low;
generating, by the information processing apparatus, an interaction element that more specifically specifies an intention of the user expressed in the natural language in a case where it is determined by the language model that the abstraction level is high;
determining, by the information processing apparatus, an execution method for planned analysis processing in a case where it is determined by the language model that the abstraction level is low;
executing, by the information processing apparatus, the analysis processing by the determined execution method;
generating, by the information processing apparatus, output information based on a result of the analysis processing; and
outputting, by the information processing apparatus, the interaction element or the output information.

22. A computer program product having a non-transitory computer readable medium including instructions stored thereon, wherein the instructions, when executed by a computer, cause the computer to function as:
an input receiver that receives input information expressed in a natural language from a user;
an analysis planning unit that determines an abstraction level of the natural language by using a language model, and plans analysis processing intended by the user by using the natural language in a case where it is determined by the language model that the abstraction level is low;
an interaction element generator that generates an interaction element that more specifically specifies an intention of the user expressed in the natural language in a case where it is determined by the language model that the abstraction level is high;
an analysis determiner that determines an execution method for planned analysis processing in a case where it is determined by the language model that the abstraction level is low;
an analysis execution unit that executes the analysis processing by the determined execution method;
an output generator that generates output information based on a result of the analysis processing; and
an output unit that outputs the interaction element or the output information.
